(19) United States
(12) Patent Application Publication
(10) Pub. No.: US 2016/0140943 A1
(43) Pub. Date: May 19, 2016

(54) MIDI DEVICES AND SYSTEMS

(71) Applicant: Integrated Technology and Entertainment Medium LLC, Inglewood, CA (US)

(72) Inventors: Nery Antonio Valladares-Madrid, Inglewood, CA (US); Niais Darren Taylor, Inglewood, CA (US); Rashad Muhammad, Studio City, CA (US)

(73) Assignee: Integrated Technology and Entertainment Medium LLC

(21) Appl. No.: 14/941,210

(22) Filed: Nov. 13, 2015

Related U.S. Application Data
(60) Provisional application No. 62/079,471, filed on Nov. 13, 2014.

(51) Int. Cl. G10H 1/00

(52) U.S. Cl. CPC G10H 1/0066; G10H 1/0083; G10H 2230/035

(57) ABSTRACT

A musical instrument digital interface (MIDI) device is configured to wirelessly connect to a MIDI dongle receiver or a Bluetooth enabled computing device, and transmit data from the MIDI controller to the computing device.

### CROSS-REFERENCE TO RELATED APPLICATION

This application claims the benefit of US Provisional Application No. 62/079,471, filed on Nov. 13, 2014. The subject matter thereof is hereby incorporated herein by reference in its entirety.

### FIELD

The present invention relates to musical instrument digital interface (MIDI) devices and systems, and more particularly, to a MIDI device for transmitting signals to, and receiving signals from, one or more MIDI controllers and a computing device.

### BACKGROUND

In the music industry, music producers, engineers, instrumentalists such as keyboard players, and the like, are required to physically connect instruments and sound processing devices to one or more MIDI controllers using one or both of MIDI cables and universal serial bus (USB) cables. MIDI cables increase the overall cost of music production, and also require space to accommodate and fit the cables. Furthermore, the MIDI cables restrict the mobility of for example, the music producer within the studio.

An alternative approach for eliminating physical cables may be beneficial.

### SUMMARY

Certain embodiments of the present invention may provide solutions to the problems and needs in the art, including those that have not yet been fully identified, appreciated, or solved by current MIDI systems. For example, in some embodiments, a MIDI system may include a MIDI device physically connected to a MIDI controller. The MIDI device may supply power to, and wirelessly transmit MIDI signals to, the computing device without the use of cables.

### BRIEF DESCRIPTION OF THE DRAWINGS

In order that the advantages of certain embodiments of the invention will be readily understood, a more particular description of the invention briefly described above will be rendered by reference to specific embodiments that are illustrated in the appended drawings. While it should be understood that these drawings depict only typical embodiments of the invention and are not therefore to be considered to be limiting of its scope, the invention will be described and explained with additional specificity and detail through the use of the accompanying drawings, in which:

FIGS. 1A-1C shows a MIDI device, according to an embodiment of the present invention.

FIG. 2 is a block diagram illustrating a circuit board for the MIDI device, according to an embodiment of the present invention.

FIGS. 3A and 3B show a MIDI dongle receiver, according to an embodiment of the present invention.

FIGS. 4A-4C show a MIDI device, according to an embodiment of the present invention.

FIGS. 5A-5C are perspective views illustrating a MIDI device, according to an embodiment of the present invention.

### DETAILED DESCRIPTION OF THE EMBODIMENTS

In some embodiments, a MIDI device may communicate MIDI signals from a MIDI controller, such as a MIDI keyboard, to a computing device wirelessly. For example, the MIDI device may wirelessly connect to, and communicate with, the computing device via Bluetooth. In another example, the MIDI device may wirelessly connect to, and communicate with, a MIDI dongle receiver, which is separate from but connected to the computing device. In some embodiments, a plurality of MIDI devices may be connected wirelessly with one computing system.

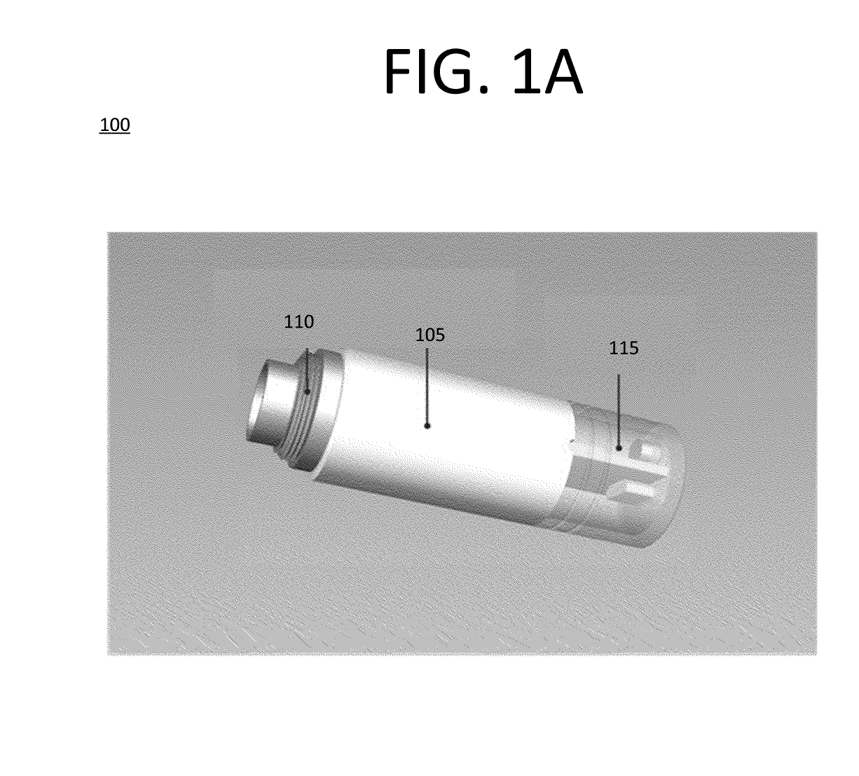

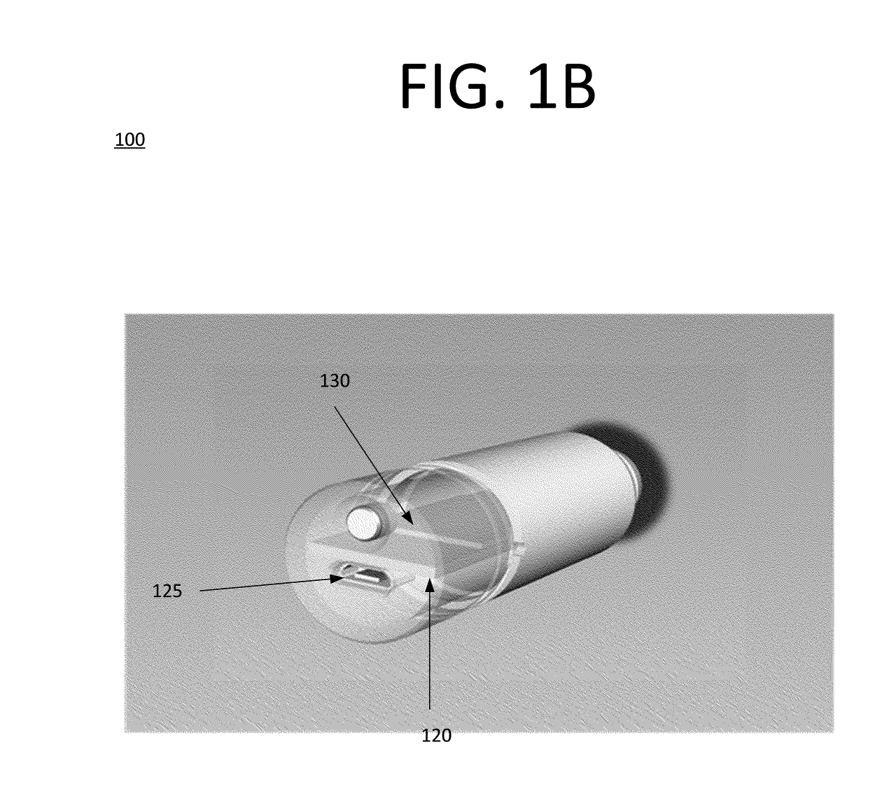

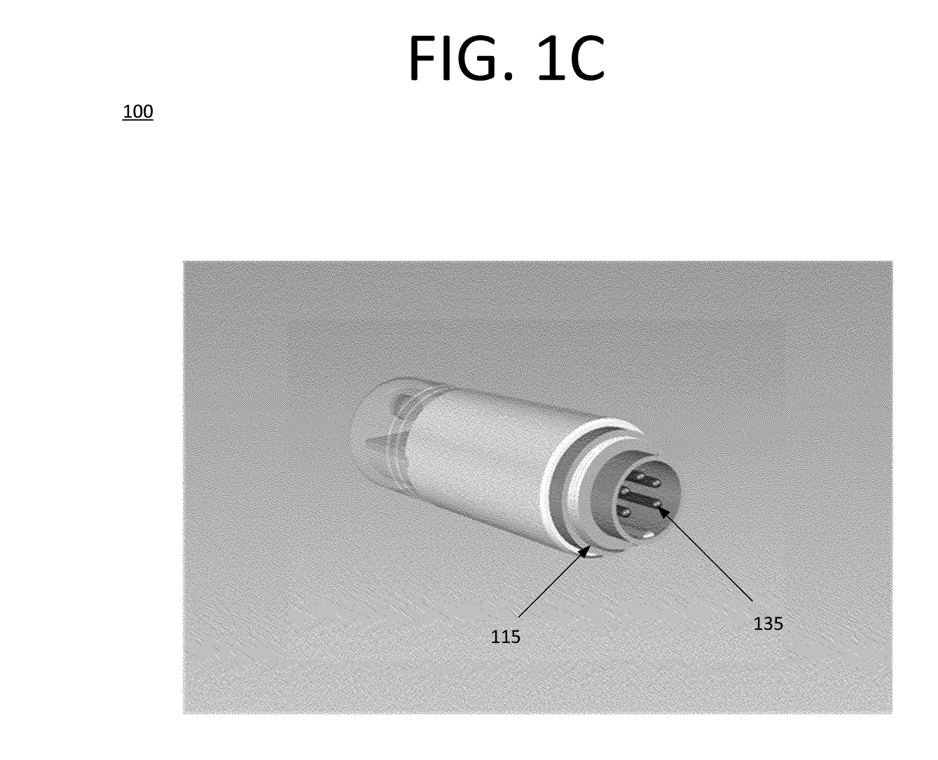

FIGS. 1A-1C show a MIDI device 100, according to an embodiment of the present invention. In some embodiments, MIDI device 100 includes a metal case 105, a MIDI connector 110, and plastic case 115 at the distal end. In certain embodiments, the case 105 and case 115 may be composed of any material such as metal, plastic, aluminum, or any suitable material now known or later developed. In some embodiments, MIDI device 100 may include a case made of non-transparent material (case 105) and transparent material (case 115) near a distal end.

MIDI device 100 may be plugged into a MIDI controller (not shown). For example, MIDI device 100 may be plugged into a MIDI out port of the MIDI controller by MIDI connector 110. In some embodiments, MIDI connector 110 may include a screw thread allowing MIDI device 100 to be screwed into the MIDI out port. See, for example, FIGS. 1A and 1C. In other embodiments, MIDI connector 110 may have a non-threaded screw to allow MIDI device 100 to slide into the MIDI out port. In either embodiment, MIDI device 100 may include a multi-prongs 135 to facilitate data communication to and from the MIDI controller and computing device.

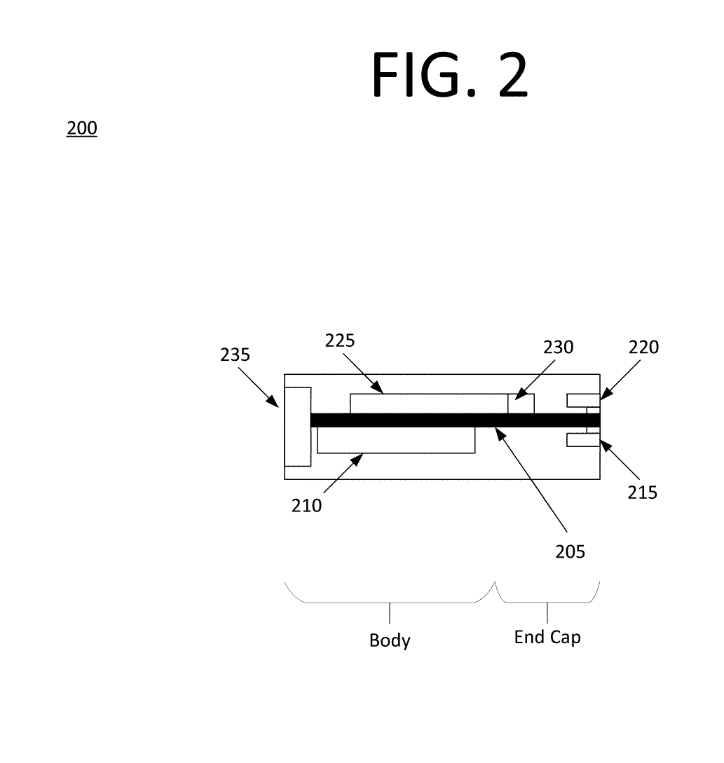

In certain embodiments, such as the one shown in FIG. 1B, MIDI device 100 may also include a circuit board 120, a USB charge port 125, and a communication device, such as an antenna 130. Antenna 130 may be Bluetooth™ enabled in some embodiments. Although not shown in FIGS. 1A-1C, MIDI device 100 may also include a power source, a power switch, and a link button. See, for example, FIG. 2.

MIDI device 100 may be a wireless MIDI signal transmission device that allows, for example, a music producer to eliminate the use of MIDI cables. MIDI device 100 may plug into any MIDI controller having a MIDI out port. MIDI device 100 may also synchronize with a computing device, such as an Apple® computing device, using Bluetooth™ low energy (or BLE), for example. It should be appreciated that a computing device may be a desktop computer, a laptop, a mobile device, a personal digital assistant, or any type of computing system that would be appreciate by a person of ordinary skill in the art. MIDI device 100 may have a communication range of at least 55 feet in some embodiments, and may continuously operate for at least 8 hours. MIDI device 100 may also include a sleep mode for power saving purposes.

FIG. 2 is a block diagram illustrating a circuit board 200 for the MIDI device, according to an embodiment of the present invention.

In some embodiments, circuit board 200 may include printed circuit board (PCB) 205, part of which may be located in the body of the MIDI device and the other part may be located in the end cap of the MIDI device. See, for example FIG. 1A. In other embodiments, PCB 205 may be located entirely within the metal body of the MIDI device. In some embodiment, PCB 205 may include a processor configured to control operation of power source 210, USB charge port 215, power switch 220, Bluetooth™ module 225, and antenna 230, and may be configured to facilitate communication between the MIDI controller and MIDI device and MIDI device and computing device (or MIDI receiver).

PCB 205 may be connected to a power source (or battery) 210 to power the MIDI device. Power source 210 in some embodiments may be a rechargeable power source via USB charge port 215, and may power the MIDI controller when connected with the MIDI device. For example, power source 210 may be recharged, when a power adapter (not shown) is plugged into an outlet, for example, and connected to the MIDI device via USB charge port 215. Charge port 125 may be a micro USB charge port in some embodiments. Power source 210 may in some embodiments include a built-in 1,000 mAH Li-Polymer rechargeable battery continuously operable for at least 6 hours. However, it should be appreciated that the embodiments described herein are not limited to a built-in 1,000 mAH Li-Polymer rechargeable battery.

PCB 205 may also be connected to a power (on/off) switch 220. Power switch 220 may power (turn) on or power (turn) off the MIDI device. In some embodiments, when power switch 220 is turned on, PCB 205 may cause the communication device, i.e., Bluetooth™ module 225 and/or antenna 230, to pair or synchronize with a MIDI receiver or a computing device.

In some embodiments, PCB 205 may be connected to a Bluetooth™ module 225 and an antenna 230. Antenna 230 may in some embodiments use radio frequency (RF) communication to transmit and receive data from another computing device or another receiver. Bluetooth™ module 225 and antenna 230 may wirelessly connect with, and transmit data, to another computing device or another receiver. For example, when the MIDI device is plugged into, or connected to, the MIDI controller via hub (or connector) 235, PCB 205 of the MIDI device may begin to receive data from the MIDI controller and transmit the received data to the computing device via Bluetooth™ 225 or antenna 230. It should be appreciated that PCB 205 of the MIDI device may allow for two-way communication, i.e., receive data from the computing device and transmit to the MIDI controller.

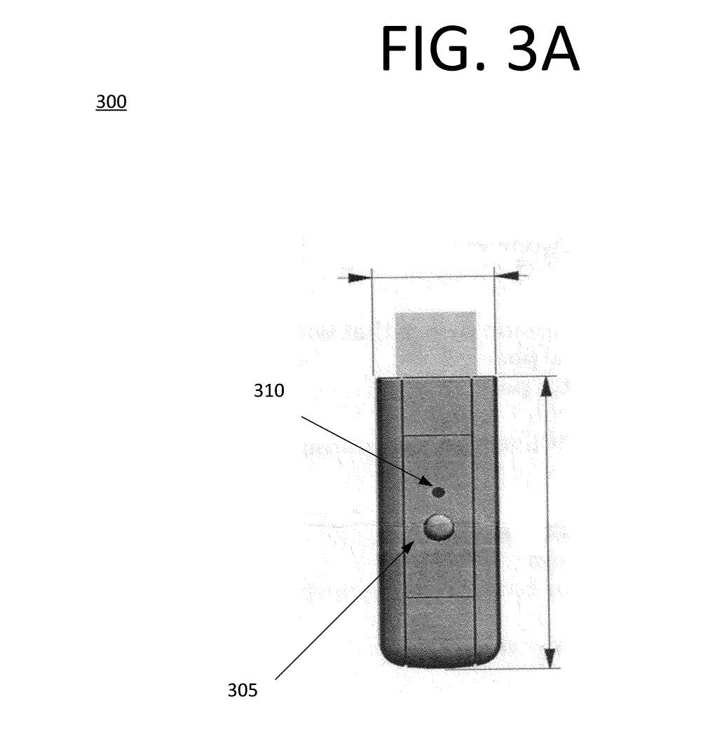

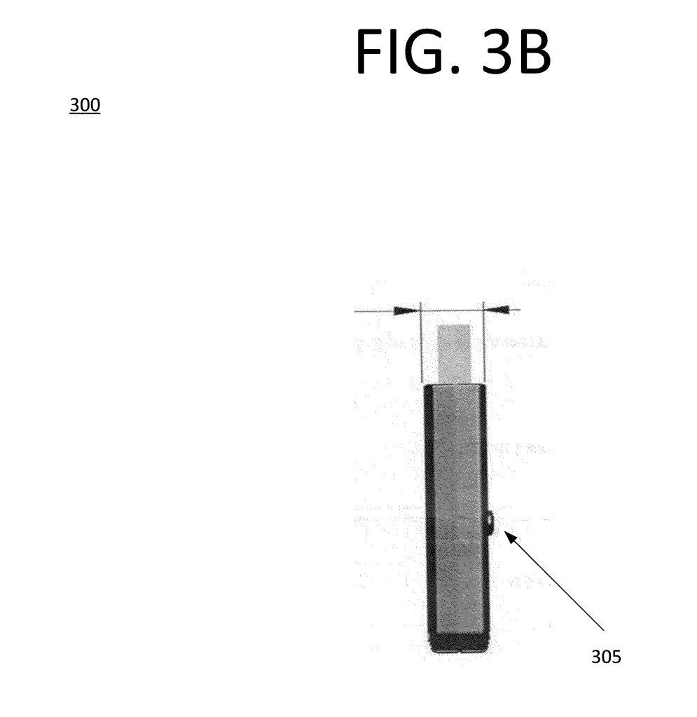

FIGS. 3A and 3B show a MIDI dongle receiver 300, according to an embodiment of the present invention. MIDI dongle receiver 300 may physically connect to a computing device (not shown) such as an Apple® computing device. MIDI dongle receiver 300 includes link button 305 and light 310. When link button 305 and a link button on the MIDI device are pressed, the MIDI device may pair or sync with MIDI dongle receiver 300. In some embodiments, synchronizing or pairing of the MIDI device with MIDI dongle receiver 300 may be performed during initial setup only, and for each subsequent use, the synchronization or pairing may not be required. Once the MIDI device and MIDI dongle receiver 300 are connected, MIDI dongle receiver 300 is configured to receive MIDI signals from the MIDI device, and transmit the received MIDI signals to the computing device.

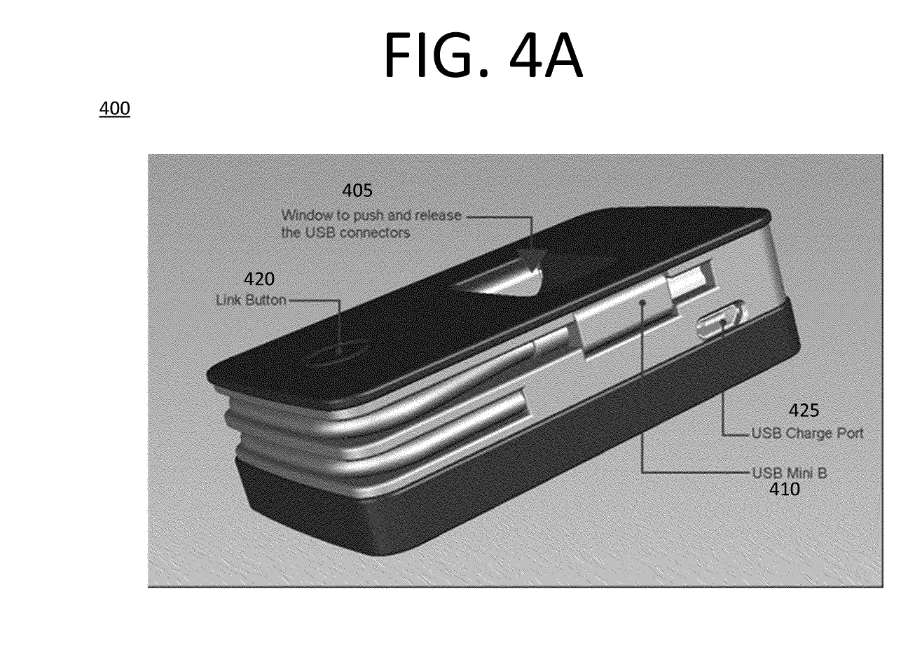

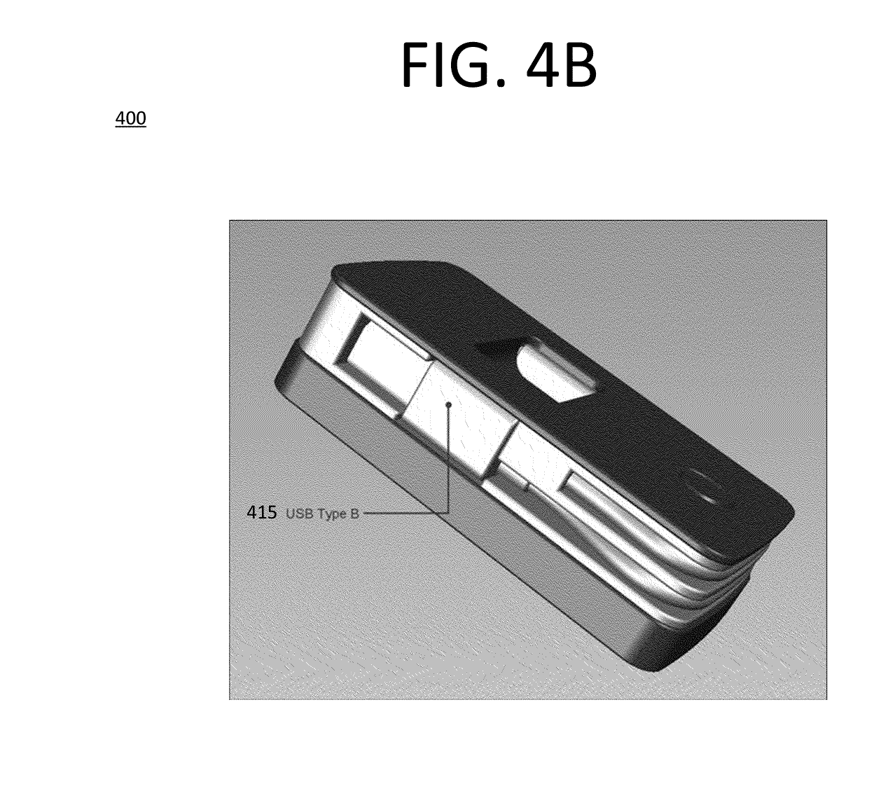

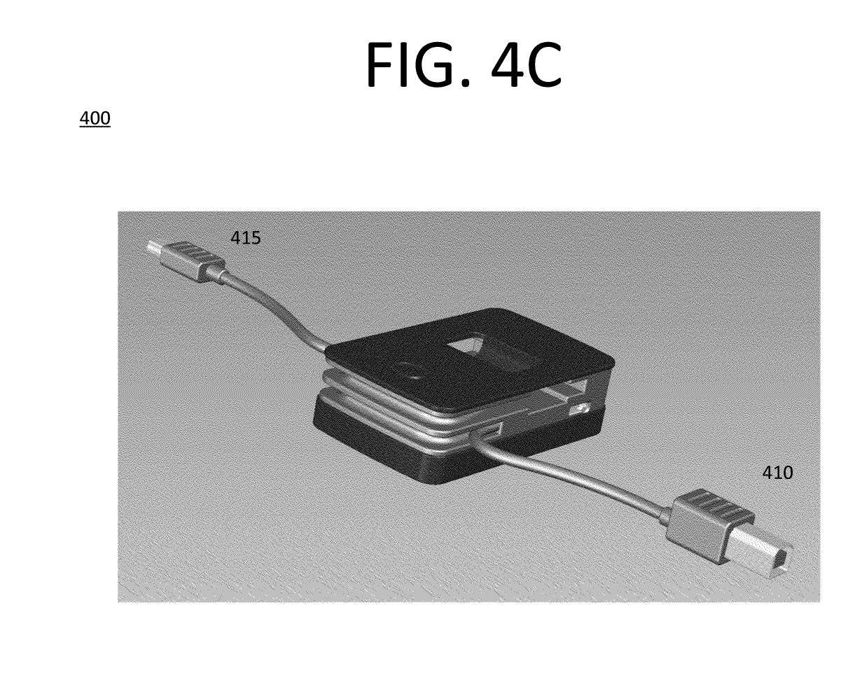

FIGS. 4A-4C show a MIDI device 400, according to an embodiment of the present invention. MIDI device 400 allows, for example, a producer, musician or a keyboardist to connect to their respective audio production software without the use of power cables or MIDI cables.

In some embodiments, MIDI device 400 may include a release button 405 to release USB type Mini-B 410 and/or Type B 415. See, for example, FIG. 4C. MIDI device 400 also includes a link button 420 that may illuminate when MIDI device 400 is turned on, and may pair MIDI device 400 with another receiver or computing device. In some embodiments, link button 420 may also flash when MIDI device 400 is being charged. Also, in some embodiments, link button 420 may remain illuminated when MIDI device 400 is completely charged, and may flash when power level of MIDI device 400 is low. In certain embodiments, MIDI device 400 may also include a charge port 425, such as a USB charge port, to charge MIDI device 400.

To operate MIDI device 400, the producer, for example, may connect MIDI device 400 to a MIDI controller (not shown) via USB type Mini-B 410 or Type B 415. Once connected to the MIDI controller, the producer is able to turn on the MIDI controller (or on some MIDI controllers, the MIDI controller will automatically power up) and launch the audio production software on the computing device. The producer may then press link button 420 to link or pair the MIDI controller with the audio production software through Bluetooth connection. For example, once the connection is made, the producer is able to move freely around the music production area, since MIDI device 400 provides power to a MIDI controller and wireless MIDI data to a computing device over Bluetooth connection.

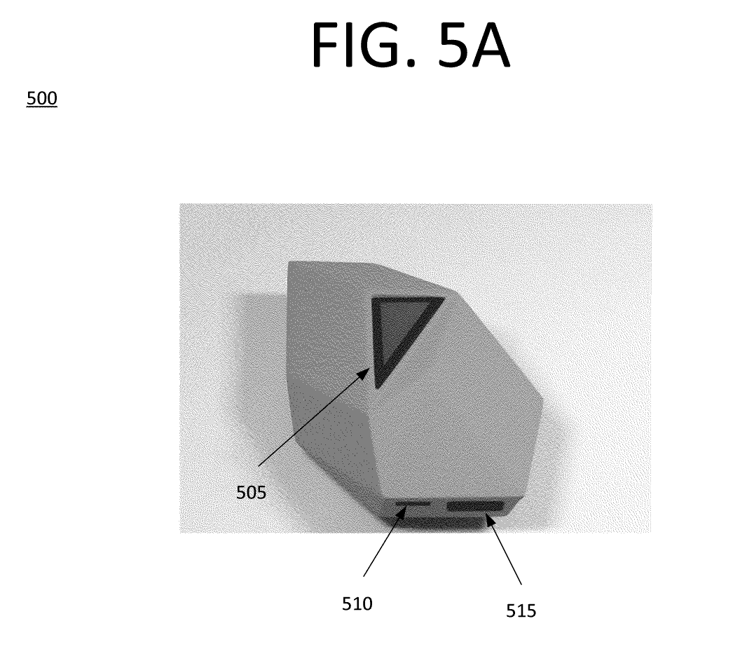

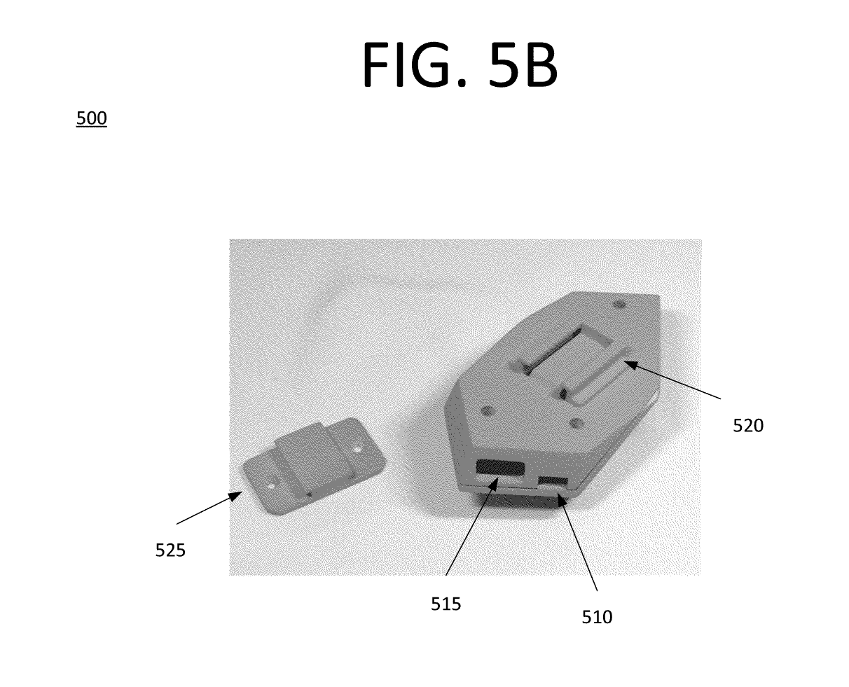

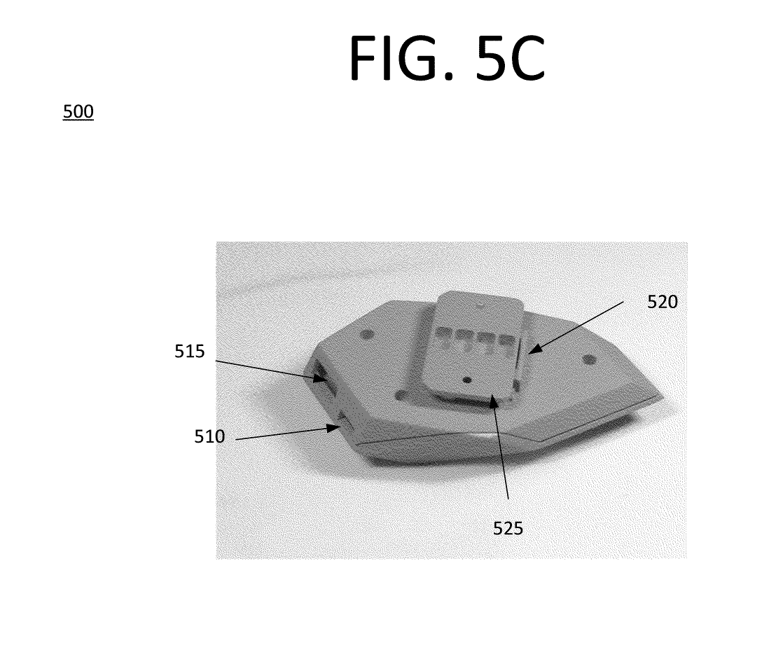

FIGS. 5A-5C are perspective views illustrating a MIDI device 500, according to an embodiment of the present invention. In some embodiments, MIDI device 500 may include a circuit board similar to the circuit board described above with respect to FIG. 2.

In order to operate MIDI device 500, a user may physically connect a MIDI controller to MIDI device 500 via MIDI connector 515. A switch (or button) 505 may be pressed by a user to turn on MIDI device 500. Similarly, to shut off MIDI device 500, the user may press switch 505. Once MIDI device 500 is turned on, MIDI device 500 using, for example, BLE may automatically search for and pair with a computing device.

Switch 505 in some embodiment may include a light (not shown). The light may be a dual-color light emitting diode in some embodiments. This light may act as an indicator to convey the state of MIDI device 500 to user. For example, the light may indicate when the power source of MIDI device 500 is being charged via charge port 510, indicate when the power source is low, indicate the connection status of MIDI device, etc.

For example, a flashing or blinking light may indicate to the user that MIDI device 500 is attempting to connect with another computing device. In one example, a blue light may indicate that MIDI device 500 is powered on. A solid blue light, for example, may indicate to the user that MIDI device 500 is connected, for example, via BLE to the other computing device. In another example, a solid red light may indicate to the user that MIDI device is not able to, or is not connected with, the other computing device. A blinking red light may indicate that the power level of power source is low in some embodiments. A blinking blue light, for example, may indicate that the power source is being charged, and may be solid blue when the power source is fully charged. These embodiments may also apply to the other embodiments described herein. In some additional embodiments, MIDI device 500, regardless of whether it is connected to a MIDI controller, may change from an OFF state to an ON state when the power source of MIDI device 500 is charging.

Once MIDI device 500 is physically connected with the MIDI controller and also wirelessly connected to the other computing device, MIDI device 500 may communicate data from the MIDI controller and to the other computing device, and visa versa. In some additional embodiments, MIDI device 500 may supply power to the MIDI controller. In some embodiments, MIDI device 500 may continuously operate for, and supply power to the MIDI controller for, 8 or more hours.

MIDI device 500 may in some embodiments change to an OFF state or a STANDBY state when the MIDI controller is disconnected or is not connected with MIDI device 500. In certain embodiments, MIDI device 500 may change form an ON state to a STANDBY state (sleep mode) when the MIDI controller is connected but is idle for a predefined period of time. In such an embodiment, the change in state of MIDI device 500 may cause the MIDI controller to change to a STANDBY state or an OFF state.

A MIDI holder 525 may hold MIDI device 500 in some embodiments. For example, MIDI holder 525 may slide into slot 520 to stabilize MIDI device 500. MIDI holder 525 may also include an adhesive opposite to the side of MIDI device 500. This adhesive may allow MIDI holder 525 be placed on a table or wall, preventing MIDI holder 525 and MIDI device 500 from moving.

One or more embodiments described herein pertain to a MIDI device that revolutionizes the way music is produced. For example, a music producer may effectively replace all MIDI cables and USB cables with the MIDI device. The MIDI device may power and transmit MIDI signals from the MIDI controller to the computing device.

To operate, the MIDI device may be plugged into a USB Type B or MINI-B connector of the MIDI controller. In one embodiment, the MIDI device may be connected to a MIDI dongle receiver, which is connected to the computing device. In other embodiments, the MIDI device may connect to the computing device via Bluetooth.

Once the MIDI device is connected with the computing device, the music producer may launch music production software on the computing device. The music production software may locate the MIDI device as the MIDI controller. This allows the MIDI device to transmit MIDI signals to the music production software

These embodiments also allows the music producer to sit anywhere in the studio with his or her keyboard without being anchored down by cables. The MIDI device relieves the music producer from the constraints of the conventional seating arrangement and the enclosure imposed by the MIDI cables. It also encourages dynamic, simultaneous creation by allowing multiple producers to connect to one creation session.

It will be readily understood that the components of various embodiments of the present invention, as generally described and illustrated in the figures herein, may be arranged and designed in a wide variety of different configurations. Thus, the detailed description of the embodiments of the present invention, as represented in the attached figures, is not intended to limit the scope of the invention, but is merely representative of selected embodiments of the invention.

The features, structures, or characteristics of the invention described throughout this specification may be combined in any suitable manner in one or more embodiments. For example, reference throughout this specification to “certain embodiments,” “some embodiments,” or similar language means that a particular feature, structure, or characteristic described in connection with the embodiment is included in at least one embodiment of the present invention. Thus, appearances of the phrases “in certain embodiments,” “in some embodiment,” “in other embodiments,” or similar language throughout this specification do not necessarily all refer to the same group of embodiments and the described features, structures, or characteristics may be combined in any suitable manner in one or more embodiments.

It should be noted that reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

One having ordinary skill in the art will readily understand that the invention as discussed above may be practiced with steps in a different order, and/or with hardware elements in configurations, which are different than those that are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

1. A musical instrument digital interface (MIDI) device, comprising:
a hub configured to connect with a MIDI controller, and receive MIDI signals from the MIDI controller;
a communication device configured to wirelessly connect with another MIDI receiver or a computing device, and transmit the MIDI signals received from the MIDI controller to the other MIDI receiver or the computing device.

2. The MIDI device of claim 1, wherein the communication device comprises a Bluetooth device or an antenna.

3. The MIDI device of claim 1, further comprising:
a case made of non-transparent material and transparent material near a distal end of the case.

4. The MIDI device of claim 1, wherein the hub comprises a USB type B, USB MINI B, or both, to connect with a MIDI controller.

5. The MIDI device of claim 1, further comprising:
a processor configured to cause the communication device to pair with, or synchronize with, the other MIDI receiver or the computing device.

6. The MIDI device of claim 1, further comprising:
a link button configured to pair or synchronize the MIDI device with the other MIDI receiver.

7. The MIDI device of claim 1, further comprising:
a power source configured to supply power to the MIDI device and supply power to the MIDI controller.

8. The MIDI device of claim 7, further comprising:
a charge port configured to recharge the power supply of the MIDI device when a power adapter is connected to the charge port.

9. The MIDI device of claim 7, wherein the power source may change from an ON state to an OFF state or a STANDBY state when the MIDI controller is idle for a predefined period of time.

10. The MIDI device of claim 9, wherein, when the power source changes from the ON state to the OFF state or the STANDBY state, the MIDI device causes the MIDI controller to change from an ON state to an OFF state or a STANDBY state.

11. The MIDI device of claim 1, further comprising:
a button to turn on the MIDI device and turn off the MIDI device.

12. The MIDI device of claim 11, wherein the button comprises a light to identify a state of the MIDI device.

13. The MIDI device of claim 12, wherein the communication device is further configured to automatically pair with or synchronize with the computing system when the MIDI device is turned on.
